(19) United States
(12) Patent Application Publication
(10) Pub. No.: US 2011/0275748 A1
(43) Pub. Date: Nov. 10, 2011

(54) METHOD FOR ADHERING ROOFING MEMBRANES

(76) Inventors: William B. Griffith, North Wales, PA (US); Don Gordon Pierson, Dresher, PA (US); Thomas J. Reffle, Southampton, PA (US)

(21) Appl. No.: 13/089,714

(22) Filed: May 5, 2011

Related U.S. Application Data
(60) Provisional application No. 61/330,925, filed on May 4, 2010.

(51) Int. Cl. C09J 193/04; C09J 133/10

(52) U.S. Cl. 524/272; 524/559

(57) ABSTRACT

A method for adhering a polyolefin roofing membrane to a roof. The method applies to the polyolefin roofing membrane an adhesive having two components. The first component is a polymer having at least 90 wt % polymerized residues of C₁-C₁₈ alkyl (meth)acrylates and C₁-C₁₈ dialkylmaleates and having a Tg no greater than −15° C. The second component is a tackifier having an acid number no greater than 50.

This application claims the benefit of priority under 35 U.S.C. §119(e) of U.S. Provisional Patent Application No. 61/330,925 filed on May 4, 2010.

This invention relates to a method for adhering roofing membranes using an acrylic polymer adhesive.

Elastomeric polyolefin membranes are used as roofing materials. The polyolefins are known to be difficult materials to bond with adhesives. Adhesive compositions containing solvents and plasticizers have been disclosed for use on polyolefins. For example, U.S. Pat. No. 4,657,958 discloses phenolic resin compositions using both solvents and plasticizers. However, the prior art does not suggest a method for adhering polyolefin membranes without the use of solvents, plasticizers, hot melt adhesives or calendared rubber based adhesives.

The problem addressed by the present invention is to provide an alternative method for adhering roofing membranes without use of solvents or plasticizers.

### STATEMENT OF INVENTION

The present invention provides a method for adhering a polyolefin roofing membrane; said method comprising applying to the polyolefin roofing membrane an adhesive comprising: (a) a polymer comprising at least 90 wt % polymerized residues of C₁-C₁₈ alkyl (meth)acrylates and C₁-C₁₈ dialkylmaleates and having a Tg no greater than −15° C.; and (b) a tackifier having an acid number no greater than 50 mg KOH/g.

### DETAILED DESCRIPTION

Percentages are weight percentages (wt %) and temperatures are in ° C., unless specified otherwise. Weight percentages of monomer residues are based on the total weight of monomer residues in the polymer. All polymer Tg values are determined by differential scanning calorimetry (DSC) according to ASTM D3418.

As used herein the term “(meth)acrylic” refers to acrylic or methacrylic, and “(meth)acrylate” refers to acrylate or methacrylate. Acrylic monomers include acrylic acid (AA), methacrylic acid (MAA), maleic acid (MA); esters of AA, MAA, and MA; itaconic acid (IA), crotonic acid (CA), acrylonitrile (AN), acrylamide (AM), methacrylamide (MAM), and derivatives of AM and MAM, e.g., alkyl (meth)acrylamides. Esters of AA, MAA, and MA include, but are not limited to, alkyl and hydroxyalkyl esters, e.g., methyl methacrylate (MMA), ethyl methacrylate (EMA), butyl methacrylate (BMA), isobutyl methacrylate (iBMA), hydroxyethyl methacrylate (HEMA), hydroxyethyl acrylate (HEA), methyl acrylate (MA), ethyl acrylate (EA), butyl acrylate (BA), ethylhexyl acrylate (EHA), isooctyl acrylate (IOA) and dioctyl maleate (DOM). The term “vinyl monomers” refers to monomers that contain a carbon-carbon double bond that is connected to an aromatic ring or a heteroatom such as nitrogen or oxygen. Examples of vinyl monomers include, but are not limited to, vinyl acetate, vinyl formamide, vinyl acetamide, vinyl pyrrolidone, vinyl caprolactam, long chain vinyl alkanoates such as vinyl neodecanoate, and vinyl stearate, and styrene. Preferably, any remaining monomer units in the polymer are derived from vinyl monomers.

For purposes of this invention, alkyl groups are saturated hydrocarbyl groups which may have straight or branched chains. The alkyl groups may be of synthetic origin and may contain a range of chain lengths. Preferably, alkyl groups are straight or branched chain acyclic groups.

Preferably, the polymer comprises at least 70 wt % polymerized residues of acrylic monomers, preferably at least 80 wt %, preferably at least 90 wt %, preferably at least 95 wt %. Preferably, the polymer comprises at least 60 wt % polymerized monomer residues of C₄-C₁₈ alkyl acrylate(s) and C₄-C₁₈ alkyl maleate(s), preferably at least 70 wt %, preferably at least 80 wt %, preferably at least 90%, preferably at least 92 wt %. Preferably, the total amount of

C₄-C₁₈ alkyl acrylate and C₄-C₁₈ alkyl maleate monomer residues is no greater than 99 wt %, preferably no greater than 98 wt %, preferably no greater than 97 wt %. The polymer may contain polymerized residues of alkyl acrylates, alkyl maleates, or a combination thereof. Preferably, the polymer comprises C₄-C₁₈ alkyl acrylate(s) residues within the above-stated limits, preferably C₄-C₁₂ alkyl acrylate(s), preferably C₄-C₈ alkyl acrylate(s). Especially preferred C₄-C₁₈ alkyl acrylate monomer residues include BA, EHA and IOA; preferably BA. Preferably, the polymer has a Tg no more than −20° C., preferably no more than −25° C., preferably no more than −30° C., preferably no more than −35° C. Preferably the polymer has a Tg no less than −70° C. One skilled in the art would be able to select monomers to arrive at any desired Tg value.

Preferably, the polymer contains no more than 2 wt % polymerized residues of acid monomers, preferably no more than 1.5 wt %, preferably no more than 1.2 wt %, preferably no more than 1 wt %, preferably no more than 0.9 wt %. Preferably, the polymer contains at least 0.2 wt % polymerized residues of acid monomers, preferably at least 0.3 wt %, preferably at least 0.5 wt %. Acid monomers include compounds having a carbon-carbon double bond and at least one substituent group which has a pKa less than 5. Examples of such substituent groups include, e.g., carboxylic acids, sulfuric and sulfonic acids, and phosphoric and phosphonic acids. Preferably any acid monomer residues present are those of carboxylic acid monomers. Preferred carboxylic acid monomers include, e.g., AA, MAA and itaconic acid, preferably AA and MAA.

Crosslinkers are monomers having two or more ethylenically unsaturated groups, and may include, e.g., divinylaromatic compounds, di-, tri- and tetra-(meth)acrylate esters, di-, tri- and tetra-allyl ether or ester compounds and allyl (meth)acrylate. Preferred examples of such monomers include divinylbenzene (DVB), trimethylolpropane diallyl ether, tetraallyl pentaerythritol, triallyl pentaerythritol, diallyl pentaerythritol, diallyl phthalate, diallyl maleate, triallyl cyanurate, Bisphenol A diallyl ether, allyl sucroses, methylene bisacrylamide, trimethylolpropane triacrylate, allyl methacrylate (ALMA), ethylene glycol dimethacrylate (EGDMA), hexane-1,6-diol diacrylate (HDDA) and butylene glycol dimethacrylate (BGDMA). Preferably, the amount of polymerized crosslinker residue in the polymer is at least 0.05 wt %, preferably at least 0.1 wt %, preferably at least 0.15 wt %, preferably at least 0.2 wt %, preferably at least 0.3 wt %, preferably at least 0.5 wt %. Preferably, the amount of crosslinker residue in the polymer is no more than 2 wt %, preferably no more than 1.5 wt %, preferably no more than 1 wt %, preferably no more than 0.8 wt %, preferably no more than 0.6 wt %. Preferably, the crosslinker is diethylenically unsaturated.

Preferably, the adhesive comprises from 40 wt % to 90 wt % of the polymer and 10 wt % to 60 wt % of the tackifier on a dry weight basis, preferably from 45 wt % to 80 wt % polymer and 20 wt % to 55 wt % tackifier, preferably from 55 wt % to 75 wt % polymer and 25 wt % to 45 wt % tackifier. Percentages are calculated on a dry weight basis. More than one polymer and/or more than one tackifier according to this invention may be present, with the total amount of polymers and tackifiers being within the amounts specified above. The adhesive comprises a tackifier having an acid number no greater than 50, preferably no greater than 40, preferably no greater than 30, preferably no greater than 20. If more than one tackifier is present, the solids-basis weight average acid number of the tackifiers is within the limits stated above. Preferably the tackifier is a rosin ester or a “hydrocarbon” (e.g., terpenes, terpene phenolics, styrenated terpenes and limonenes) tackifier, preferably a rosin ester, e.g., with glycerol or pentaerythritol. Preferably, the tackifier has a softening point less than 150° C., preferably less than 120° C., preferably less than 100° C. Preferably, the tackifier has a softening point no less than 20° C. The tackifier may be in the form of an aqueous dispersion having from 40 to 70 wt % solids. The adhesive may also contain pigments, adhesion promoters (e.g., chlorinated polyolefins, polyolefins and copolymers thereof), surfactants, defoamers, thickeners, fillers and post added crosslinkers, e.g., multivalent cations. The water content of the adhesive may vary from 40 wt % to 80 wt %, preferably from 50 wt % to 75 wt %, preferably from 55 wt % to 70 wt %. Preferably, the adhesive contains less than 10 wt % plasticizers, preferably less than 5 wt %, preferably less than 3 wt %, preferably less than 1 wt %. Preferably, the adhesive contains less than 5 wt % of solvents other than water, preferably less than 1 wt %, preferably less than 0.5 wt %.

The adhesive may further comprise a surfactant-stabilized dispersion of polyolefins, preferably polymers of ethylene, propylene and mixtures thereof. Examples of such dispersions include the HYPOD polyolefin dispersions available from The Dow Chemical Company. Typically, the adhesive would contain up to 15% of a polyolefin dispersion, preferably up to 10%, on a solids basis.

Preferably, the polymers used in this invention are prepared by copolymerizing the monomers using well known emulsion polymerization processes, and any other suitable processes known in the art, using, for example, a free-radical initiator such as peroxygen compounds or diazo compounds and, optionally, chain transfer agents. The length of the primary polymer chains is typically such that, if any crosslinks were removed, the molecular weight (M_{w}) would be in the range of about 50,000 to 10,000,000, preferably from 100,000 to 5,000,000, preferably from 200,000 to 2,000,000. Polymer latexes produced by emulsion polymerization typically have from 40 to 75 wt % polymer solids, preferably 50 to 70 wt %.

In the method of this invention, the adhesive is applied to a polyolefin roofing membrane (TPO) to secure the membrane to the roof decking or other support. Supports to which the adhesive and roofing membrane may be applied include stone, concrete, asphalt, wood, particle or fiber board, isocyanurate insulator board, polystyrene insulator board, metal and fiber glass mat faced gypsum board. Typically, the adhesive is applied in an amount from 10 to 1000 g/m², preferably from 50 to 500 g/m², preferably from 100 to 350 g/m². Preferably, the composition is cured under ambient conditions without external heating, ventilation or humidity control, although these may be used as needed. Preferably, the ambient air temperature is from 5° C. to 45° C.

### EXAMPLE

### Adhesive

The adhesive was formulated with 64 parts of an aqueous dispersion of a polymer of 95.7 BA/3 MMA/0.8 AA/0.5 AM (parts by weight, 65% solids in water, Tg: −38° C.) and 36 parts of a glycerol rosin ester tackifier with a softening point of about 80° C. (SNOWTACK 780G, acid number <20), on a dry weight basis.

Comparative Adhesives

Comp #1 is: 79% (95 BA/2.5 VAc/2.5 AN) and 21% tackifer which is a blend of 67% rosin acid (acid number˜120) and 33% of an alpha-methyl styrene based tackifier (acid number 0).

Comp 2 is 75% (93 BA/7 AN) and 25% rosin acid tackifier (acid number 120).

Standard Testing

Standard preparation was to coat 2 grams of adhesive on a 6″×3″ (15.2×7.6 cm) area of wood and 0.8 grams of adhesive on a 6″×1″ (15.2×2.5 cm) strip of TPO. The samples were air dried until they were clear, then laminated together at ambient temperature with six passes of a 10 pound (22 kg) steel roller, then placed in a controlled temperature room (23° C., 50% RH) for 24 hours. The samples were tested according to ASTM D3330, with 180 degree peels measured at a rate of 2″/min (5.1 cm/min), with the results tabulated below.

180° Peel lb/in (N/2.54 cm)

| | 1 day | 7 days | 28 days |
|---|---|---|---|
| Example | 9.0 (40) | 8.6 (38) | 7.3 (32) |
| Comp 1 | 9.1 (40) | 10.6 (47) | 11.2 (50) |
| Comp 2 | 14.4 (64) | 14.0 (62) | 3.0 (13) |

### Humidity Resistance:

Coat 0.8 grams of adhesive onto a 6″×1″ (15.2×2.5 cm) strip of TPO. Let samples dry under ambient conditions for 4 hours. Submerge samples in water for 7 days at ambient temperature. Remove, shake off excess water and let equilibrate in a controlled temperature room (23° C., 50% RH) for 15 minutes. Loop tack was measured on stainless steel according to test method ASTM-6195. Results are shown below.

| Sample | Loop Tack, oz (N) | Finger Rub Test |
|---|---|---|
| Example | 10.4 (2.9) | 5 |
| Comp. 1 | 4.2 (1.2) | 1 |
| Comp. 2 | 0.4 (0.1) | 2 |

The finger rub test is a subjective test that evaluates anchorage on TPO immediately after removing it from water. In this case, the sample is rubbed with light pressure.
1=Adhesive can be removed very easily
2=Adhesive can be removed easily
5=Difficult to remove adhesive.

Qualitative peel force at various temperatures were measured by hand on samples prepared as described above.

| | 6° C. | 0° C. |
|---|---|---|
| Example | 4 | 2 |
| Comp 1 | 1 | 1 |
| Comp 2 | 1 | 1 |

1=very easy to delaminate, slight to no force
2=easy to delaminate, moderately light force
3=moderate to delaminate, moderate force
4=hard to delaminate, strong force require to delaminate
5=cannot delaminate without destroying substrate

1. A method for adhering a polyolefin roofing membrane; said method comprising applying to the polyolefin roofing membrane an adhesive comprising: (a) a polymer comprising at least 90 wt % polymerized residues of C₁-C₁₈ alkyl (meth)acrylates and C₁-C₁₈ dialkylmaleates and having a Tg no greater than −15° C.; and (b) a tackifier having an acid number no greater than 50.

2. The composition of claim 1 in which the adhesive comprises from 40 to 90 wt % of the polymer and from 10 to 50 wt % of the tackifier.

3. The composition of claim 2 in which the polymer comprises at least 70 wt % monomer residues of at least one monomer selected from the group consisting of C₄-C₁₈ alkyl acrylates, C₄-C₁₈ alkyl maleates.

4. The composition of claim 3 in which the polymer contains no more than 1.5 wt % polymerized residues of acid monomers.

5. The composition of claim 4 in which the tackifier has an acid number no greater than 30.

6. The composition of claim 5 in which the polymer comprises at least 80 wt % polymerized residues of C₄-C₈ alkyl acrylates.

7. The composition of claim 6 in which the tackifier is a rosin ester.

8. The composition of claim 7 in which the adhesive comprises 45 wt % to 80 wt % of the polymer and 20 wt % to 55 wt % of the tackifier.

9. The composition of claim 8 in which the polymer contains no more than 1.2 wt % polymerized residues of acid monomers.

10. The composition of claim 9 in which the polymer comprises at least 90 wt % polymerized residues of C₄-C₈ alkyl acrylates.
